(19) United States
(12) Patent Application Publication
(10) Pub. No.: US 2010/0325182 A1
(43) Pub. Date: Dec. 23, 2010

(54) DOWNLOADABLE MULTIMEDIA WITH ACCESS CODES

(75) Inventor: Howard Ganz, North York (CA)

Correspondence Address: Pearne & Gordon LLP, 1801 East 9th Street, Suite 1200, Cleveland, OH, 44114-3108, US

(73) Assignee: GANZ, an Ontario partnership consisting of 2121200 Ontario Inc., and 2121812 Ontario Inc., Woodbridge (CA)

(21) Appl. No.: 12/486,383

(22) Filed: Jun. 17, 2009

(51) Int. Cl. G06F 17/30

(52) U.S. Cl. 707/957; 707/759

(57) ABSTRACT

Multimedia items are legally downloaded with a code usable on another website. The codes can be used once or a set number of times in order to encourage legal downloading of multimedia through positive incentives such as bonus content (e.g., codes); however the multimedia items themselves can be viewed or accessed multiple times.

### BACKGROUND

The system described in our U.S. Pat. No. 7,425,169, the entire contents of which are herewith incorporated by reference, describes an online system where the user can log into a computer, and store information indicative of multiple different avatars within that computer. For example, in our patent, users purchase tangible items, e.g., toys or other figurines. Each purchased item is associated with a unique code.

A computer system accepts the unique code and retrieves a pre-stored profile indicative of the item that was pre-associated with that unique code. Therefore, the user gets both a tangible item and an online persona that has at least one characteristic that is similar to the tangible item. The user can then interact with the online persona via a website. The user can also carry out various activities on the website to earn points, and then can use the points to buy various items that are usable on the website.

### SUMMARY

The present application describes a technique of coupling downloads with codes to provide the ability to obtain additional content as part of the download. According to one embodiment, the download is of a multimedia content, and the codes are related to the downloaded content.

### BRIEF DESCRIPTION OF THE DRAWINGS

FIG. 1 shows an embodiment.

### DETAILED DESCRIPTION

Illegally downloaded material deprives its proper owners of a certain amount of income. However, downloadable content is inevitably pirated and shared between and amongst people, since digital copying can be used for simple content sharing. People have little or no motivation to download legal versions.

The present inventors recognized that providing some incentive for the users to download legally would likely result in more legal downloading and less illegal downloading. The present application describes a system, operation and method for legally downloading content, where the legally downloaded content is coupled with supplemental information that is associated with network based content.

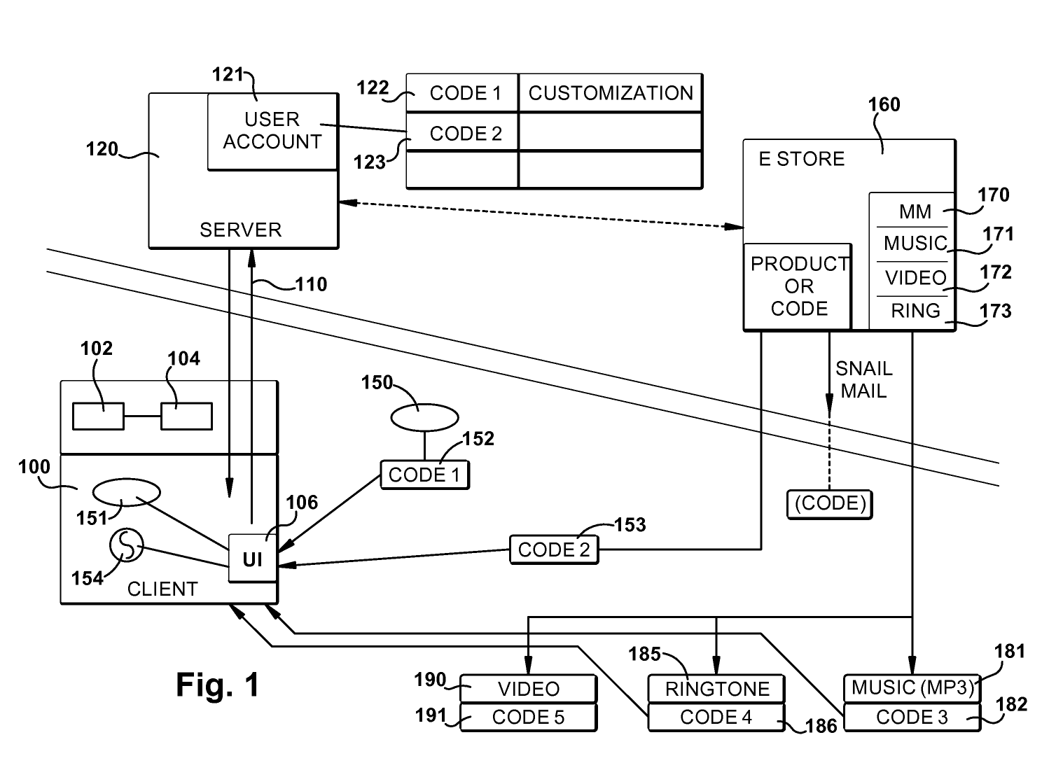

FIG. 1 shows an embodiment. A client 100 can be a personal computer, a portable computer such as a PDA or cell phone, or a dedicated gaming computer, such as a Microsoft® Xbox, or a portable version of a computer game. The client 100 includes a processor 102 that runs a stored program 104 that commands and carries out the operations described herein.

One of the operations carried out by the stored program 104 is to create a user interface 106. The user interface 106 accepts commands and produces outputs which collectively provide content to be seen and/or heard and/or otherwise viewed by a user, as well as accepting commands from the user using conventional input devices such as touch screen, mouse, keyboard, voice recognition, or any other input technique.

According to one aspect, the user interface 106 running on the computer may interface with or be part of a web browser program. The web browser program may interact with a server computer 120 which also runs its own programs. The interaction may occur over a network 110 such as the Internet.

In operation, in one mode, a user buys a product shown generally as 150. The product includes a code 152 shown as code_1. The code 152 is either attached to the product, or on a tag associated with the product or otherwise affixed thereto. The product code_1 is entered into the user interface 106, and communicated over the network 110 to the server 120.

The program running on the server 120 verifies code_1, to determine if code_1 is authorized, whether it has already been used, and its meaning. The server 120 determines that code_1_means that the user has bought a product that looks like 150, and accordingly returns information to provide a virtual representation of the product 150. The virtual representation is shown as 151, shown for example on the display screen of the client computer 100. The server computer 110 also stores information indicative of the code 152 or the virtual representation 151 into a user account shown generically as 121. The different entries in the account represent the code such as code_1 122, and information about the code, e.g., an expiration date, and any customizations that may have been carried out with respect to the product. For example, the user may be allowed to customize the product or buy additional things for the product, and these may form information for the customization. Thereafter, a user who logs into their user account 121 automatically receives all of the information that is recorded or stored in their user account 121.

In one embodiment, the products can be toys, e.g., stuffed animals or figurines. Other products can be collectibles or accessories.

In addition to buying products such as 150, there is an Estore 160 which also sells products or codes. The codes that are sold by the Estore 160 are usable on the site run by the server 120. In the case of buying product 150, the product is purchased, and this comes with a code. In the Estore, codes are purchased, with or without products. However, the code is purchased first in the Estore 160, and any physical product is delivered only later to the user. For example, a user can purchase a code shown as code_2 153. This code is entered by a user into the user interface 106 for the site 100. Once entered and validated, the code 153 provides a virtual representation of a ball shown as 154. As in the other embodiments, the code_2 153 is stored in the user account along with any customization data. The products and the virtual representation may interact with one another.

The code may be electronically obtained from the Estore as shown in the figure, or in another embodiment, may be sent through a conventional postal system or by e-mail to the user. The Estore may interact with the server 120 to obtain valid codes or to communicate the information about or associated with any obtained codes.

According to another embodiment, the Estore 160 allows downloads of multimedia content shown in 170. In one embodiment, these downloads are carried out for a fee. The multimedia content may include music 171, videos 172 or ring tones 173 for example. However, the multimedia content may also include other kinds of content besides those specific content forms.

Users who pay to download the multimedia content (i.e., a legal download) also receive a code with the content. Users download an item of multimedia which includes a code associated therewith. The code is separate from said item of multimedia, and said code can be used by the user on the website—in a wholly different way than the user who plays the multimedia. The code can be manually entered into the website by a user, in which embodiment the code may be viewed by the user, either separately or during the playing of the multimedia. The code can alternatively be automatically entered into the website by the computer that plays the multimedia the next time the website is visited but after the multimedia is played on a computer.

In the embodiment, the Estore 160 obtains a number of single or multiple-use codes which are usable on server 120 to obtain some virtual representations of products on site 100. Each user who legally downloads some item of multimedia gets one of those codes. Once used, the Estore does not again use, generate or provide that code. The code might be usable only once, or can be used a set number of times, such as five times.

For example, FIG. 1 shows the user downloading the music file 180, and with that, receives a code_3 182. That code is then usable on the website 100, to obtain a virtual representation on the website 100, and to make an entry indicative of that code in the user's account.

In one embodiment, the virtual representation represented by code_3 may be a virtual representation that is related to the content of the multimedia, e.g., the music. For example, the virtual representation may be a picture of the artist, or some trademark of the artist, for example the artist's look or clothing worn by the artist, or something else that makes the artist unique. It may, for example, represent information about the content of the song, for example for a song about a “rag doll”, the virtual representation that is downloaded by the code could be a virtual representation of a rag doll that can be interacted with by a user on the site 100, can be customized, and then stored in the user's account.

The code can be other things, for example, the code can be redeemed for a ring tone. The ring tone can be downloaded from a web site responsive to entering the code, or received directly into a user's cell phone, e.g., by SMS.

Additionally, a ring tone 185 can be a form of multimedia that comes with a code_4 186. The ring tone 185 could be anything related to the virtual representation obtained from code_4, such as a sound the virtual representation might make, or the like.

A downloaded video may also include a code shown as 191. The code for the downloaded video can be, for example, a character or some other aspect of the video.

In one embodiment, each downloadable item may have multiple different possible forms that correspond to the code, which are assigned at random. For example, in this embodiment, for multimedia content_1, there might be 25 different virtual representations that can be obtained at random when downloading multimedia content_1. A user who downloads multimedia content 1 gets a unique code, but does not know to which of the virtual representations that code will correspond. Once the code is entered, the user gets a virtual representation, but the specific representation they get is a surprise to them. The user gets one version which is selected at random for a legal download of some multimedia. However, another user might get a different version of the virtual representation after entering the code.

As an alternative to the “surprise” embodiment, the user can receive an option when downloading the multimedia. For example, the user downloading a song can receive a screen that says “you can get one of the following things, which one do you want? (A) bunny, (B) virtual cash, or (C) ring tone.”

Another embodiment gives the same virtual representation to all users downloading the multimedia content.

Since the server computer 120 verifies the code, it only allows each code to be used once. As a result, users are encouraged to perform more downloads legally rather than illegally in order to obtain more codes.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of protections can be used to further protect the copyrighted materials in addition to this system, e.g., digital rights management, DRM.

Also, the inventors intend that only those claims, if any, which use the words “means for” are intended to be interpreted under 35 USC 112, sixth paragraph. The computers which are used to host the website and/or to access the website may be any kind of computer, either general purpose, or some specific purpose computer such as a workstation. For example, the computer may be an Intel (e.g., Pentium or Core 2 duo) or AMD based computer, running Windows® XP or Linux, or may be a Macintosh computer. The computer may also be, for example, a handheld or other mobile computer, such as a PDA, cellphone, or laptop or a special purpose computer such as a game console.

The programs may be written in any suitable programming language, such as C, Python, Java, Brew or other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

What is claimed is:

1. A method comprising:
using a computer for downloading an item of multimedia which includes a code associated therewith, said code being separate from said item of multimedia, and said code being usable by a user separate from a playing of the multimedia; and
using the computer for entering said code on a website to obtain content on the website.

2. A method as in claim 1, wherein the code used on the website can only be used a single time on the website.

3. A method as in claim 1, wherein the code used on the website can only be used a set number of times on the website.

4. A method as in claim 1, further comprising using the computer for playing the multimedia.

5. A method as in claim 1, wherein said content on the website comprises content associated with said multimedia.

6. A method as in claim 1, where said content on the website is a virtual item which can be interacted with on the website, and further comprising interacting with the content on the website separate from playing the multimedia.

7. A method as in claim 1, wherein said multimedia is music.

8. A method as in claim 5, wherein said multimedia is music, and said content on the website comprises content associated with a subject of the music.

9. A method as in claim 5, wherein said multimedia is music, and said content on the website comprises content associated with an artist of the music.

10. A method as in claim 1, wherein said multimedia is a video.

11. A method as in claim 5, wherein said multimedia is a video, and said content on the website comprises content associated with a subject of the video.

12. A method as in claim 1, wherein said multimedia is a ring tone.

13. A method as in claim 5, wherein said multimedia is a ring tone, and said content on the website comprises content associated with an object that could be associated with the ring tone.

14. A method as in claim 1, wherein said content obtained from the website is a ring tone.

15. A method comprising:
using a computer for hosting a website that controls obtaining items of multimedia and allows selling said items of multimedia;
using the computer for obtaining plural codes which are usable on the website, each code being usable on the website to automatically obtain content on the website detecting a request for download of a first multimedia item;
first controlling a download by a first user of the first multimedia item along with a first code from said plural codes, said first code associated with said first multimedia item;
preventing said first code from being downloaded again after said first controlling;
second controlling a download by a second user of the first multimedia item along with a second code from said plural codes, said second code associated with said first multimedia item; and
preventing said second code from being downloaded again after said first controlling.

16. A method as in claim 15, wherein said content on said website is content which cannot be obtained without said code.

17. A method as in claim 15, wherein said first and second controlling comprises providing an option to a user of multiple different options of what the code will represent on the website.

18. A method as in claim 15, wherein said first and second codes represent content on another website that is associated with said first multimedia item.

19. A method as in claim 18, where said content on the website is a virtual item which can be interacted with on the another website, and further comprising interacting with the content on the another website separate from playing the first multimedia item.

20. A method as in claim 15, wherein said multimedia is music.

21. A method as in claim 16, wherein said multimedia is music, and said content on the another website comprises content associated with a subject of the music.

22. A method as in claim 16, wherein said multimedia is music, and said content on the another website comprises content associated with an artist of the music.

23. A method as in claim 15, wherein said multimedia is a video.

24. A method as in claim 15, wherein one of said codes represents a ring tone.

25. A method as in claim 15, wherein said multimedia is a ring tone.

26. A method as in claim 18, wherein said multimedia is a ring tone, and said content on the website comprises content associated with an object that could be associated with the ring tone.

27. A method comprising:
using a computer for downloading an item of multimedia which includes a bonus item associated therewith, said bonus item being separate from said item of multimedia, and said bonus item being usable by a user separate from a playing of the multimedia; and
obtaining said bonus item separately from obtaining said item of multimedia.

28. A method as in claim 27, wherein said bonus item is a ring tone.
